(19) United States
(12) Patent Application Publication
(10) Pub. No.: US 2025/0222700 A1
(43) Pub. Date: Jul. 10, 2025

(54) Method and Processing Unit for Stabilizing the Printing Operation of an Inkjet Printing Device

(71) Applicant: Canon Production Printing Holding B.V., Venlo (NL)

(72) Inventors: Matthias Kage, Haar (DE); Markus Keller, Schrobenhausen (DE); Benno Petschik, Markt Schwaben (DE)

(21) Appl. No.: 19/014,331

(22) Filed: Jan. 9, 2025

(30) Foreign Application Priority Data
Jan. 10, 2024 (DE) 10 2024 100 636.6

(51) Int. Cl. B41J 2/21; G06K 15/02

(52) U.S. Cl. CPC B41J 2/2139; B41J 2/2121; B41J 2/2135; B41J 2/2142; G06K 15/027; G06K 2215/101

(57) ABSTRACT

A processing unit for an inkjet printing device is described that is designed to calibrate the ink ejection of the individual nozzles of the printing device within the scope of a uniformity test, and to permanently deactivate nozzles that had failed within the scope of the uniformity test. An especially stable printing operation of the printing device can thus be ensured.

### CROSS-REFERENCE TO RELATED APPLICATION

This application claims priority to German Patent Application No. 10 2024 100 636.6 filed Jan. 10, 2024, the disclosure of which is hereby incorporated by reference in its entirety.

### BACKGROUND OF THE INVENTION

### Technical Field

The invention relates to a method and a corresponding processing unit for operating an inkjet printing device, in particular in order to enable an optimally stable printing operation of the printing device.

### Description of Related Art

An inkjet printing device for printing to a recording medium has at least one print bar with one or more print heads having respectively a plurality of nozzles. The nozzles are respectively configured to eject ink droplets in order to print dots of a print image onto the recording medium. The print bar and the recording medium are thereby moved relative to one another in order to print dots onto the recording medium at different positions, in particular in different lines, and thus in order to print a print image onto the recording medium.

Over time, failures of individual nozzles can occur due to various influences, wherein nozzle failures can possibly be temporary, for example given the presence of a temporary inclusion of air into the nozzle chamber of a nozzle.

### SUMMARY OF THE INVENTION

The present document deals with the technical object of enabling a stable and qualitatively high-grade printing operation even given the presence of nozzle infills, in particular of temporary nozzle failures. The object is respectively achieved via the features of the device as described herein as well as via the features of the method as described herein.

According to one aspect, a processing unit for an inkjet printing device is described that comprises at least one print bar having a plurality of nozzles, wherein the plurality of nozzles is configured to print dots in a corresponding plurality of columns of a print image onto a recording medium. The processing unit is configured to effect that a first test print image is printed onto the recording medium by the plurality of nozzles for a uniformity test, and that, from the plurality of nozzles, the set of nozzles is identified that failed in the printing of the first test print image. The plurality of nozzles of the print bar without the identified set of failed nozzles can be designated as a complementary set of nozzles.

The processing unit is also configured to determine, depending on the first test print image, calibration data that establish a respective ink quantity to be ejected by the respective nozzle for the individual nozzles of the complementary set of nozzles. Furthermore, the processing unit is configured to effect, for the printing operation of the printing device following the uniformity test, that the identified set of failed nozzles is deactivated, and that the complementary set of nozzles is operated on the basis of the calibration data.

According to a further aspect, a method is described for operating an inkjet printing device. The method comprises effecting that a first test print image is printed onto a recording medium by the plurality of nozzles for a uniformity test. Furthermore, the method comprises the identification, from the plurality of nozzles of the printing device, of the set of nozzles that failed in the printing of the first test print image. The method also comprises determining, depending on the first test print image, calibration data that establish the respective ink quantity to be ejected by the respective nozzle for the individual nozzles of the complementary set of nozzles. Moreover, the method comprises effecting, for the printing operation of the printing device following the uniformity test, that the identified set of failed nozzles is deactivated, and that the complementary set of nozzles is operated on the basis of the calibration data.

### BRIEF DESCRIPTION OF THE DRAWINGS

The terms Fig., Figs., Figure, and Figures are used interchangeably in the specification to refer to the corresponding figures in the drawings.

In the following, exemplary embodiments of the invention are described in detail using schematic drawings. Thereby shown are:

FIG. 1 a block diagram of an example of an inkjet printing device;

FIG. 2a an example of a test print image for a uniformity test;

FIG. 2b an example of a test print image for the detection of one or more failed nozzles;

FIG. 2c example calibration data for the plurality of nozzles of a printing device; and

FIG. 3 a workflow diagram of an example of a method for operating an inkjet printing device.

The non-limiting embodiments of the present invention will be described with reference to the accompanying drawings. Elements, features and components that are identical, functionally identical and have the same effect are, insofar as is not stated otherwise, respectively provided with the same reference character.

### DESCRIPTION OF THE INVENTION

In the following description, numerous specific details are set forth in order to provide a thorough understanding of the embodiments of the present invention. However, it will be apparent to those skilled in the art that the embodiments, including structures, systems, and methods, may be practiced without these specific details. Well-known methods, procedures, components, and circuitry have not been described in detail to avoid unnecessarily obscuring embodiments of the invention. The connections shown in the figures between functional units or other elements can also be implemented as indirect connections, wherein a connection can be wireless or wired. Functional units can be implemented as hardware, software or a combination of hardware and software.

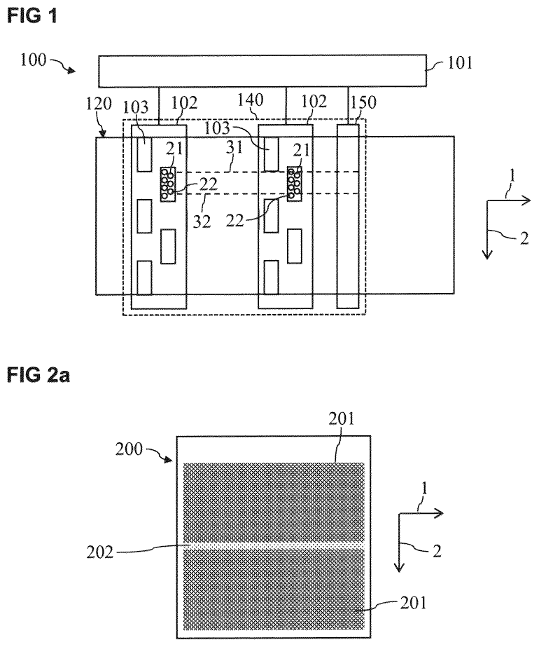

The printing device 100 depicted in FIG. 1 is designed for printing to a recording medium 120 in the form of a sheet or page or plate or belt. The recording medium 120 can be produced from paper, paperboard, cardboard, metal, plastic, textiles, a combination thereof, and/or other materials that are suitable and can be printed to. The recording medium 120 is directed through the print group 140 of the printing device 100 along the transport direction 1, represented by an arrow.

In the depicted example, the print group 140 of the printing device 100 comprises two print bars 102, wherein each print bar 102 can be used for printing with ink of a defined color, for example black, cyan, magenta, and/or yellow, and MICR ink if applicable. Different print bars 102 can be used for printing with respective different inks. Furthermore, the print group can comprise at least one sensor unit 10, for example a camera or a scanner, that is configured to acquire sensor data with regard to a print image printed onto the recording medium 120. Alternatively, the sensor unit 150 can be separate from the printing device 100. A recording medium 120 that is printed to by the printing device 100 can be detected by the separate sensor unit 150.

A print bar 102 can comprise one or more print heads 103 that, if applicable, are arranged side by side in a plurality of rows in order to print the dots of different columns 31, 32 of a print image onto the recording medium 120. In the example depicted in FIG. 1, a print bar 102 comprises five print heads 103, wherein each print head 103 prints the dots of a group of columns 31, 32 of a print image onto the recording medium 120. The different columns 31, 32 of a print image are arranged side by side along the transverse direction 2. Furthermore, the individual columns 31, 32 respectively run along the transport direction 1.

In the embodiment depicted in FIG. 1, each print head 103 of the print group 140 comprises a plurality of nozzles 21, 22, wherein each nozzle 21, 22 is configured to fire or eject ink droplets toward the recording medium 120. A print head 103 of the print group 140 can, for example, comprise multiple thousands of effectively utilized nozzles 21, 22 that are arranged along a plurality of rows transverse to the transport direction 1 of the recording medium 120, i.e. along the transverse direction 2. Dots of a row of a print image can be printed onto the recording medium 120 transverse to the transport direction 1, i.e. along the width of the recording medium 120, by means of the nozzles 21, 22 of a print head 103, or of a print bar 102, of the print group 140.

The printing device 100 also comprises a control or processing unit 101, for example a driving hardware and/or a controller, that is configured to drive actuators of the individual nozzles 21, 22 of the individual print heads 103 of the print group 140 in order to apply a print image onto the recording medium 120 depending on print data. In an exemplary embodiment, the control or processing unit 101 includes processing circuitry or at least one processor that is configured to perform one or more functions and/or operations of the control or processing unit 101, including activating the actuators of the individual nozzles 21, 22 of the individual print heads 103 of the print group 140 to apply the print image onto the recording medium 120 based on print data, processing print and/or other data, control one or more modes of the printer device 100 and/or controlling one or more operations of the printing device 100. In an exemplary embodiment, the control or processing unit 101 includes one or more interfaces (e.g. a wired and/or wireless input and/or output interface, transceiver, or the like) that are configured to receive or output data or information. For example, the control or processing unit 101 may receive signals generated by one or more components of the printing device 100 (e.g. from a user interface of the printer device 100) and/or output control signals to one or more components of the printing device 100. In an exemplary embodiment, the control or processing unit 101 includes a memory configured to store data/information, and/or store executable code that is executable by the processing circuitry to cause the processing circuitry or at least one processor to perform the operation(s) of the control or processing unit 101.

As presented above, an impairment of individual nozzles 21, 22 of a print head 103 or of a print bar 102 can occur in the course of the operation of the printing device 100. In particular, failures of individual nozzles 21, 22 can occur over time, wherein a nozzle 21, 22 can fail permanently or only temporarily.

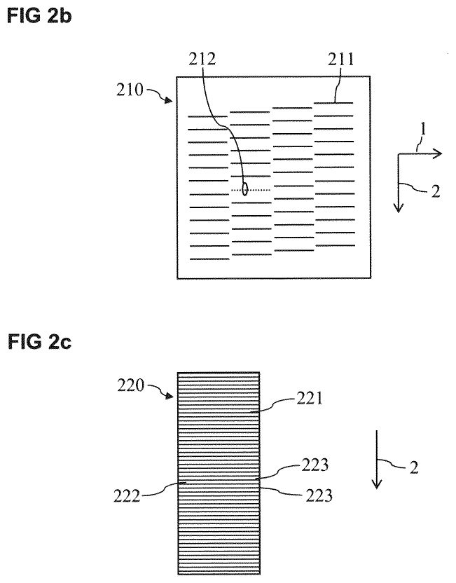

In order to determine the state of the individual nozzles 21, 22 of the printing device 100, a test print image 210 with a test pattern can be printed, as is depicted by way of example in FIG. 2b. The test pattern can comprise individual lines 211, wherein each line 211 is respectively printed by precisely one single nozzle 21, 22. Every single nozzle 21, 22 of the printing device 100 can thus be induced to print precisely one line 211. The test print image 200 with the test pattern can be detected by the sensor unit 150.

On the basis of the sensor data of the sensor unit 150, i.e. on the basis of the detected test print image 210, for every single nozzle 21, 22 a check can be made as to whether the respective nozzle 21, 22 is impaired or not, in particular has failed or not. In particular, for example, it can be detected that a defined line 212 is missing in the printed test print image 210. From this, it can be concluded that the nozzle 21, 22 corresponding to the defined line 212 has failed. Accordingly, the failure of a plurality of nozzles 21, 22 can be detected given the absence of a plurality of lines 202 in the detected test print image 210. The individual failed nozzles 21, 22 can also be identified. A set of failed nozzles 21, 22 can thus be identified on the basis of a test print image 210 detected by the sensor unit 150.

The print quality of an inkjet printing device 100 can be increased by performing a uniformity test and, based upon this, a calibration of the individual nozzles 21, 22. FIG. 2a shows an example of a test print image 200 that can be printed by the printing device 100 for a uniformity test. For this purpose, the individual nozzles 21, 22 can be induced to eject respective ink droplets with a uniform ink quantity in the individual rows of the test print image 200. If all nozzles 21, 22 respectively eject ink droplets with a uniform ink quantity, a consistently inked print image 210 is printed onto the recording medium 120. However, inconsistencies can occur in the printed test print image 200 due to impairments and/or calibration differences of the nozzles 21, 22. The test print image 200 depicted in FIG. 2a has consistently inked regions 201 and an insufficiently inked region 202, wherein the insufficiently inked region 202 was possibly caused by a failed nozzle 21, 22.

The test print image 200 for the uniformity test can be detected by the sensor unit 150. Calibration data 220 for the subsequent operation of the plurality of nozzles 21, 22 of the printing device 100 can also be determined based on the test print image 200, which calibration data 220 are intended to at least partially or entirely or make up for a detected inconsistency of the test print image 200. The calibration data 220 can be determined such that, if the test print image 200 were to be reprinted under consideration of the calibration data 200, the reprinted test print image 200 has an increased degree of consistency as compared to the originally printed test print image 200.

For the individual nozzles 21, 22, the calibration data 220 can have a respective nozzle entry 221 that, for example, establishes.
one or more properties of the ink ejection pulse with which the respective nozzle 21, 22 is driven for the ejection of an ink droplet to print a dot; and/or
the ink quantity that is ejected within an ink droplet to print a dot; and/or
whether the respective nozzle 21, 22 is activated (and thus is driven during the printing operation) or deactivated (and thus is not driven during the printing operation).

The calibration data 220 depicted in FIG. 2c have a nozzle entry 222 for the failed nozzle 21, 22. In this nozzle entry 222, it can be stored that the nozzle 21, 22 is deactivated, and thus is not driven in the following printing operation.

The calibration data 220 depicted in FIG. 2c also have one or more nozzle entries 223 for accordingly one or more adjacent nozzles 21, 22 that are arranged directly neighboring the failed nozzle 21, 22. These one or more nozzle entries 223 can indicate that the one or more corresponding nozzles 21, 22 eject an increased ink quantity (in comparison to the standard quantity) in the following printing operation, in order to at least partially or entirely compensate for the failed nozzles 21, 22, and in order to thereby be able to print a relatively consistently inked test print image 200 in spite of a failed nozzle 21, 22.

Alternatively, or in combination with this, the correction of the ink quantity takes place per nozzle track, in that the number of ejected droplets, in particular droplets of equal size, is adapted in said nozzle track. Ink droplets are thus ejected more often or more rarely. A nozzle track describes a (virtual) line in the printing direction, which line is generated on the recording medium by a single nozzle. Depending on the design of a print head, only a plurality of nozzles can be adapted, or only all nozzles, since in such an instance at least only a single waveform (=the electrical driving pulse shape) is available for the plurality of or for all actuators, such that it is hardly possible to vary the ink quantity of the individual dots. In the following, it is described that the individual ink droplets can be adapted for the CUC. What is meant by this is also the adaptation of the ink quantity within the nozzle track.

Within the scope of a uniformity test, a test print image 200 can thus be printed by the nozzles 21, 22 of a print bar 102 and subsequently be detected by the sensor unit 150, wherein the test print image 200 should have as a target specification a consistent, uniform inking. All nozzles 21, 22 of the print bar 102 are preferably activated for the printing of the test print image 200. The actual printed test print image 200 represents the real state of the print bar 102. In particular, the actual printed test print image 200 can have at least one sub-region 201 with a non-uniform inking, wherein this sub-region 201 is to be ascribed to a failed nozzle 21, 22, for example.

Based on the actual printed test print image 200 and based on the comparison of this real state with the target specification, the calibration data 220 can be determined that are used for the subsequent printing operation of the print bar 102 in order to ensure an optimally consistent inking.

On the basis of the test print image 200 for the uniformity test and/or on the basis of a dedicated test print image 210 for the detection of nozzle failures, a set of failed nozzles 21, 22 can also be identified that have failed in the uniformity test, i.e. in the printing of the test print image 200. The one or more nozzles 21, 22 from the set of failed nozzles 21, 22 are deactivated for the subsequent printing operation of the print bar 102.

During the subsequent printing operation, the print bar 102 can be operated with the determined calibration data 220 and with the deactivated set of failed nozzles 21, 22. A gentler, more robust, and qualitatively higher-grade printing operation can thus be ensured. In particular, it can thus be reliably avoided that, during the subsequent printing operation, the print quality is negatively affected by a nozzle 21, 22 that had temporarily failed during the uniformity test but that recovers again during the subsequent printing operation.

As has already been presented, individual nozzle failures can occur at the print heads 103. These can be caused by different effects such as, for example:
a fouling of the nozzle plate;
a dried-up nozzle 21, 22;
air in a nozzle 21, 22;
a faulty driving of a nozzle 21, 22; and/or
a defective piezoelectric actuator of a nozzle 21, 22.

Distracting lightened—in particular white—regions, what are known as “nozzle outs,” thereby result in the print image. These print image errors may occur permanently or temporarily, and may disappear again after some time.

An adjustment of the actuators of the different print heads 103 of a print bar 102 can be implemented in the start-up of a printing device 100, for example. In particular, the electrical voltage at the actuators can thereby be adjusted, for example in order to effect that the different print heads 103 produce a uniform inking, for example with a uniform tonal value. A consistency or uniformity of the printing operation of the different print heads 103 of a print bar 102 can thus be effected.

What is known as a Color Uniformity Correction (CUC) can also be implemented in order to effect that an optimally consistent inking of a test print image 200 is produced, as is presented by way of example in conjunction with FIG. 2a. The goal of the CUC is to ensure a consistent inking over the entire printing width of the print bar 102. This can be implemented online, during the printing operation, or offline, outside of the printing operation. To detect the consistency, a test print image 200 can be printed out, and the printed test print image 200 can be detected with an external or internal sensor unit 150, for example by a scanner, and be analyzed via an evaluation software.

Nozzle failures of the print bar 102 can be treated as an inconsistency of the inking and can be compensated for by increasing the ink application via the adjacent nozzles 21, 22 of a failed nozzle 21, 22. For this purpose, in the calibration data 220 of the individual nozzles 21, 22 it can be stored, for the adjacent nozzles 21, 22, that ink droplets are ejected with an increased ink quantity.

Given a temporary nozzle failure, this CUC can result in an overcompensation being visible in the print image as soon as the nozzle 21, 22 that had failed in the printing of the test print image 200 for the CUC functions again. The print image artifact that thereby appears corresponds to a dark region in a print image.

As is presented in this document, the one or more nozzles 21, 22 can be identified that had failed at the point in time of the printing of the test print image 200 for the CUC. The one or more failed nozzles 21, 22 can be identified directly from the printed test print image 200 for the CUC. Alternatively or additionally, to identify failed nozzles 21, 22, an additional test print image 210 can be printed and evaluated in order to identify the one or more failed nozzles 21, 22.

The one or more identified failed nozzles 21, 22 can be permanently deactivated for the following printing operation. An overcompensation during the printing operation can thus be reliably avoided.

The one or more identified failed nozzles 21, 22 can remain deactivated until the implementation of a subsequent CUC. On the other hand, the one or more deactivated nozzles 21, 22 can preferably be reactivated in advance of the implementation of a subsequent CUC, in particular such that all nozzles 21, 22 of the print bar 102 are activated for the printing of the test print image 200 for the subsequent CUC. As a result of this, one or more nozzles 21, 22 that had only temporarily failed can be re-integrated into the active printing operation.

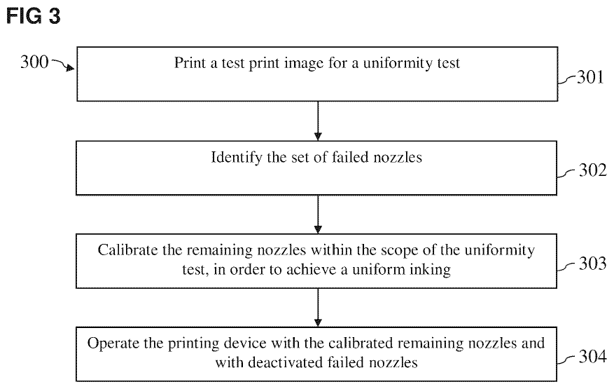

FIG. 3 shows a workflow diagram of an example of a method 300 for operating an inkjet printing device 100. The method 300 can be executed by a processing unit 101 of the printing device 100. The method 300 can be designed to enable an especially stable operation of the printing device 100 with a stable print quality.

The inkjet printing device 100 comprises at least one print bar 102 having a plurality of nozzles 21, 22, for example 100 or more or 1000 or more nozzles 21, 22. The plurality of nozzles 21, 22 can be arranged in one or more print heads 103. The plurality of nozzles 21, 22 is configured to print dots in a corresponding plurality of columns 31, 32 of a print image onto a recording medium 120. A one-to-one relation can thereby exist between the individual nozzles 21, 22 and the corresponding columns 31, 32.

The method 300 comprises effecting 301 that a first test print image 200 is printed onto the recording medium 120 by the plurality of nozzles 21, 22 for a uniformity test. The test print image 200 can, as a target specification, correspond to a uniformly inked area. The goal of the uniformity test can thus be to print a uniformly inked area onto the recording medium 120. In the event that the actual printed first test print image 200 does not exhibit a uniform inking, a correction of the ink quantity ejected per dot by the individual nozzles 21, 22 can be performed within the scope of a calibration, in order to effect that the plurality of nozzles 21, 22 produces a uniform inking following the calibration. This process is also referred to in this document as a Color Uniformity Correction (CUC).

The method 300 also comprises the identification 302 of, from the plurality of nozzles 21, 22, a set of nozzles 21, 22 that had failed in the printing of the first test print image 200. The set of failed nozzles 21, 22 can possibly be identified directly on the basis of the printed first test print image 200. Alternatively or additionally, a second test print image 210, in particular a line pattern, can be printed that is specialized for the detection of individual failed nozzles 21, 22.

The plurality of nozzles 21, 22 of the print bar 102 without the identified set of failed nozzles 21, 22 forms a complementary set of nozzles 21, 22. The complementary set of nozzles 21, 22 can thus comprise all nozzles 21, 22 of the print bar 102 that were not identified as failed nozzles 21, 22.

Furthermore, the method 300 comprises determining 303, depending on the first test print image 200, calibration data 220 that establish a respective ink quantity to be ejected by the respective nozzle 21, 22 for the individual nozzles 21, 22 of the complementary set of nozzles 21, 22. The calibration data 220 can be particularly advantageously determined under the assumption that the identified set of failed nozzles 21, 22 that have been deactivated is not available for the printing of dots.

The calibration data 220 can establish, for the individual nozzles 21, 22 of the complementary set of nozzles 21, 22, the respective ink quantity that is ejected by the respective nozzle 21, 22 for the printing of a dot. To determine the calibration data 200, one or more degraded sub-regions 201 that have too little inking can be identified in the printed first test print image 200. The ink quantity of the nozzles 21, 22 by which the one or more degraded sub-regions 201 are printed, said ink quantity having been established by the calibration data 220, can be increased in order to increase the inking of the one or more degraded sub-regions 201.

The calibration data 220 can be determined such that a uniformly inked area is printed on the recording medium 120 by the plurality of nozzles 21, 22, in particular by the complementary set of nozzles 21, 22, given consideration of the calibration data 220.

The method 300 also comprises effecting 304, for the printing operation of the printing device 100 subsequent to the uniformity test, that.
the identified set of failed nozzles 21, 22 is deactivated, and thus is not driven for the printing of dots; and
the complementary set of nozzles 21, 22 is operated on the basis of the calibration data 220.

A high print quality can thus be effected in a stable manner during the printing operation.

A processing unit 101 for an inkjet printing device 100 is thus described that comprises at least one print bar 102 having a plurality of nozzles 21, 22. The individual nozzles 21, 22 are respectively configured to print dots in corresponding columns 31, 32 of a print image onto a recording medium 120.

The processing unit 101 is configured to effect that a first test print image 200 is printed by the plurality of nozzles 21, 22 onto the recording medium 120 for a uniformity test, in particular for a CUC. The first test print image 200 can be detected, in particular scanned, by a sensor unit 150. The analysis of the first test print image 200 can be implemented on the basis of the detected, in particular scanned, version of the first test print image 200.

The processing unit 101 is also configured to identify, from the plurality of nozzles 21, 22, a set of nozzles 21, 22 that had failed in the printing of the first test print image 200. The set of failed nozzles 21, 22 can be identified on the basis of the first test print image 200, in particular on the basis of one or more sub-regions 201 of the first test print image 200, that are not inked or are only inked less strongly than average. Alternatively or additionally, it can be effected that a second test print image 210 is printed onto the recording medium 120 for the identification of the set of failed nozzles 21, 22, in particular directly before or directly after the printing of the first test print image 200 for the uniformity test. The second test print image 210 can have a plurality of lines 211 spaced apart from one another for the corresponding plurality of nozzles 21, 22. The set of failed nozzles 21, 22 can then be particularly precisely identified, if applicable also on the basis of the second test print image 210, in particular on the basis of one or more absent lines 212 of the second test print image 210.

Furthermore, the processing unit 101 is configured to determine calibration data 220 depending on the first test print image 200. The calibration data 200 can establish, for the individual nozzles 21, 22 of the complementary set of nozzles 21, 22, the respective ink quantity to be ejected by the respective nozzle 21, 22, in particular for the printing of a dot. The calibration data 200 can establish the respective waveform of the ejection pulse, for example for the individual nozzles 21, 22, wherein the ejected ink quantity results from the waveform of the ejection pulse.

The processing unit 101 can be configured to determine the calibration data 220 such that, and/or with the goal that, the first test print image 200 would be printed by the complementary set of nozzles 21, 22 on the recording medium 120 with a more consistent, uniform inking, on the basis of the calibration data 220, than the first test print image 200 that was actually printed on the recording medium 120 for the uniformity test. The calibration data 220 can thus produce an approximation of a uniform inking.

For this purpose, the processing unit 101 can be configured to identify a degraded sub-region 202 of the first test print image 200 that is less strongly inked than another sub-region 201 of the first test print image 200. The group of nozzles 21, 22 by which the degraded sub-region 202 of the first test print image 200 was printed can also be identified. Calibration data 220 can then be determined for the identified group of nozzles 21, 22, via which it is effected that an increased ink quantity is ejected by said group of nozzles 21, 22. Via the calibration data 220, it can thus be effected that the degraded sub-region 202 is more strongly inked, and that the uniformity of the inking is increased as a result of this.

The target specification for the first test print image 200 can be a uniformly inked area on the recording medium 120. In other words, the first test print image 200 can be designed such that a uniformly inked area, as a first test print image 200, is printed onto the recording medium 120 by an error-free and correctly calibrated print bar 102.

The processing unit 101 can be configured to identify one or more sub-regions 201, of the first test print image 200 actually printed onto the recording medium 120, that were not uniformly inked, in particular were inked too little. By comparison of the actual inking with the target specification for the inking, calibration data 220 can then be determined via which the ink quantity respectively ejected per dot by the individual nozzles 21, 22 of the complementary set of nozzles 21, 22 is varied such that the one or more identified sub-regions 201 are inked uniformly, in particular according to the target specification for the inking.

Furthermore, the processing unit 101 is configured to effect, for the printing operation of the printing device 100 following the uniformity test, that.
the identified set of failed nozzles 21, 22 is deactivated; and
the complementary set of nozzles 21, 22 is operated on the basis of the calibration data 220.

It can be effected in particular that the identified set of failed nozzles 21, 22 remains deactivated during the printing operation, preferably until the implementation of the following uniformity test, so that the identified set of failed nozzles 21, 22 is not activated for the printing of dots during the printing operation.

The ink ejection of the individual nozzles 21, 22 of the complementary set of nozzles 21, 22 can also take place according to the ink quantities established in the calibration data 200.

A processing unit 101 for an inkjet printing device 100 is thus described that is designed to calibrate the ink ejection of the individual nozzles 21, 22 of the printing device 100 within the scope of a uniformity test, and to permanently deactivate nozzles 21, 22 that failed within the scope of the uniformity test. An especially stable printing operation of the printing device 100 can thus be ensured.

The processing unit 101 can also be configured to effect that the identified set of failed nozzles 21, 22 is activated for a subsequent uniformity test, so that the identified set of failed nozzles 21, 22 is activated for the printing of dots of the first test print image 200 for the subsequent uniformity test. It can thus be reliably effected that nozzles 21, 22 that had only temporarily failed are re-incorporated into the printing operation, in order to further increase the print quality of the printing device 100.

According to a further aspect, an inkjet printing device 100 is described that comprises the processing unit 101 described in this document.

Print image artifacts due to temporarily failed nozzles 21, 22 can be reliably avoided via the measures described in this document. Homogeneous print images can thus be continuously ensured, and the printing stability can be increased. The implementation of CUCs in reaction to the detection of overcompensations in a print image can also be avoided, whereby the printing efficiency can be increased. Furthermore, the service life of the print heads 103 can be increased.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general-purpose computer.

For the purposes of this discussion, the terms “processing circuitry” and “processing unit” shall be understood to be circuit(s) or processor(s), or a combination thereof. A circuit includes an analog circuit, a digital circuit, data processing circuit, other structural electronic hardware, or a combination thereof. A processor includes a microprocessor, a digital signal processor (DSP), central processor (CPU), application-specific instruction set processor (ASIP), graphics and/or image processor, multi-core processor, or other hardware processor. The processor may be “hard-coded” with instructions to perform corresponding function(s) according to aspects described herein. Alternatively, the processor may access an internal and/or external memory to retrieve instructions stored in the memory, which when executed by the processor, perform the corresponding function(s) associated with the processor, and/or one or more functions and/or operations related to the operation of a component having the processor included therein. In one or more of the exemplary embodiments described herein, the memory is any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

### Reference List

1 transport direction
2 transverse direction
21, 22 nozzle
31, 32 column
100 printing device
101 control or processing unit
102 print bar
103 print head
120 recording medium
140 print group
150 sensor unit
200 test print image (uniformity test)
201 consistently inked region
202 insufficiently inked region
210 test print image (to detect a failed nozzle)
211 printed line
212 missing line
220 calibration data
221 nozzle entry
222 nozzle entry for a failed nozzle
223 nozzle entry for an adjacent nozzle
300 method for operating an inkjet printing device
301-304 method steps

What is claimed is:

1. A processing unit for an inkjet printing device that comprises at least one print bar having a plurality of nozzles; wherein the plurality of nozzles is configured to print dots in a corresponding plurality of columns of a print image onto a recording medium, the processing unit comprising at least one processor configured to:
control the inkjet printing device to print a first test print image onto the recording medium by the plurality of nozzles for a uniformity test;
identify, from the plurality of nozzles, a set of nozzles that failed in the printing of the first test print image; wherein the plurality of nozzles of the print bar without the identified set of failed nozzles forms a complementary set of nozzles;
determine, depending on the first test print image, calibration data that establish a respective ink quantity to be ejected by a respective nozzle of the nozzles of the complementary set of nozzles; and
for a printing operation of the printing device following the uniformity test,
deactivate the identified set of failed nozzles; and
operate the complementary set of nozzles based on the calibration data.

2. The processing unit according to claim 1, wherein the at least one processor is further configured to identify the set of failed nozzles based on the first test print image.

3. The processing unit according to claim 1, wherein the at least one processor is further configured to:
control the inkjet printing device to, for the identification of the set of failed nozzles, print a second test print image onto the recording medium; and
identify the set of failed nozzles based on the second test print image.

4. The processing unit according to claim 1, wherein the at least one processor is further configured to control the identified set of failed nozzles to remain deactivated during the printing operation until the implementation of a subsequent uniformity test, so that the identified set of failed nozzles is not driven for the printing of dots during the printing operation.

5. The processing unit according to claim 1, wherein the at least one processor is further configured to control the identified set of failed nozzles to be activated for a subsequent uniformity test, so that the identified set of failed nozzles is driven for the printing of dots of the first test print image for the subsequent uniformity test.

6. The processing unit according to claim 1, wherein the at least one processor is further configured to determine the calibration data such that the first test print image is printed by the complementary set of nozzles, based on the calibration data, with a more consistent uniform inking than the first test print image that was actually printed on the recording medium for the uniformity test.

7. The processing unit according to claim 1, wherein the at least one processor is further configured to:
identify a degraded sub-region of the first test print image that is less strongly inked than another sub-region of the first test print image;
identify a group of nozzles by which the degraded sub-region of the first test print image was printed; and
determine calibration data for the identified group of nozzles, via which calibration data it is effected that an increased ink quantity is ejected by the group of nozzles.

8. The processing unit according to claim 1, wherein
a target specification for the first test print image is a uniformly inked area on the recording medium; and
the at least one processor is further configured to:
identify one or more sub-regions, of the first test print image that was printed on the recording medium, that are not uniformly inked; and
determine calibration data via which the ink quantity respectively ejected per dot by the individual nozzles of the complementary set of nozzles is varied such that the one or more identified sub-regions are inked uniformly and/or the ink quantity within a nozzle track of a nozzle can be adapted via the number of ejected ink droplets such that the one or more identified sub-regions are inked uniformly.

9. The processing unit according to claim 1, wherein the at least one processor is further configured to analyze a scanned version of the first test print image printed onto the recording medium, in order to determine the calibration data.

10. A method for operating an inkjet printing device that comprises at least one print bar having a plurality of nozzles; wherein the plurality of nozzles is configured to print dots in a corresponding plurality of columns of a print image onto a recording medium, the method comprising
printing with the inkjet printing device a first test print image onto the recording medium by the plurality of nozzles for a uniformity test;
identifying, from the plurality of nozzles, a set of nozzles that failed in the printing of the first test print image; wherein the plurality of nozzles of the print bar, without the identified set of failed nozzles, forms a complementary set of failed nozzles;
determining, depending on the first test print image, calibration data that establish a respective ink quantity to be ejected by a respective nozzle of the nozzles of the complementary set of nozzles; and
for a printing operation of the printing device following the uniformity test,
deactivating the identified set of failed nozzles; and
operating the complementary set of nozzles based on the calibration data.

11. The method according to claim 10, further comprising identifying the set of failed nozzles based on the first test print image.

12. The method according to claim 11, wherein the set of failed nozzles is identified based on one or more sub-regions of the first test print image that are not inked or inked only less strongly than an average.

13. The method according to claim 10, further comprising
controlling the inkjet printing device to, for the identification of the set of failed nozzles, print a second test print image onto the recording medium; and
identifying the set of failed nozzles based on the second test print image.

14. The processing unit according to claim 13, wherein the second test print image is printed directly before or directly after the printing of the first test print image for the uniformity test and the second test print image has a plurality of lines spaced apart from one another for the corresponding plurality of nozzles.

15. The processing unit according to claim 14, wherein the set of failed nozzles is identified based on one or more missing lines of the second test print image.

16. The method according to claim 10, further comprising controlling the identified set of failed nozzles to remain deactivated during the printing operation until the implementation of a subsequent uniformity test, so that the identified set of failed nozzles is not driven for the printing of dots during the printing operation.

17. The method according to claim 10, further comprising controlling the identified set of failed nozzles to be activated for a subsequent uniformity test, so that the identified set of failed nozzles is driven for the printing of dots of the first test print image for the subsequent uniformity test.

18. The processing unit according to claim 2, wherein the at least one processor is further configured to identify the set of failed nozzles based on one or more sub-regions of the first test print image that are not inked or inked only less strongly than an average.

19. The processing unit according to claim 3, wherein the second test print image is printed directly before or directly after the printing of the first test print image for the uniformity test and the second test print image has a plurality of lines spaced apart from one another for the corresponding plurality of nozzles.

20. The processing unit according to claim 12, wherein the set of failed nozzles is identified based on one or more missing lines of the second test print image.
